(19) United States
(12) Patent Application Publication
(10) Pub. No.: US 2015/0103387 A1
(43) Pub. Date: Apr. 16, 2015

(54) SHUTTER-BASED LIGHT MODULATORS INCORPORATING INTEGRATED SIDEWALL REFLECTORS

(71) Applicant: Pixtronix, Inc., San Diego, CA (US)

(72) Inventors: Joyce Wu, Somerville, MA (US); Jianru Shi, Haverhill, MA (US); Mark Andersson, Northborough, MA (US); George Robert Beebe, Acton, MA (US)

(73) Assignee: Pixtronix, Inc., San Diego, CA (US)

(21) Appl. No.: 14/052,103

(22) Filed: Oct. 11, 2013

(51) Int. Cl. G02B 26/02; B29D 11/00; G02B 5/136

(52) U.S. Cl. CPC G02B 26/02; G02B 5/136; B29D 11/00605
USPC 359/230; 264/1.1

(57) ABSTRACT

This disclosure provides systems, methods, and apparatus for a MEMS display incorporating integrated sidewall reflectors. The display can include a light blocking component suspended over a substrate. The light blocking component can include an aperture in its surface that is parallel to the substrate. The display can include one or more sidewall reflectors positioned within the aperture. The one or more sidewall reflectors can be arranged at least partially normal to the surface of the light blocking component. Light that is directed through the aperture can be reflected off of the sidewall reflectors to escape from the display at a higher angle than would otherwise be possible.

### TECHNICAL FIELD

This disclosure relates to the field of displays, and in particular, electromechanical systems (EMS) display elements.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus. The display apparatus includes a substrate and a display element. The display element includes a light blocking component suspended over the substrate. The light blocking component includes an aperture formed through a surface of the light blocking component that is substantially parallel to the substrate. The aperture has a perimeter edge, a first axis and a second axis. The first axis is longer than, and perpendicular to, the second axis. The display element includes a first sidewall positioned within the aperture and spaced away from the perimeter edge of the aperture, extending substantially parallel to the first axis and oriented at least partially normal to the surface of the light blocking component.

In some implementations, the first sidewall can be spaced less than or equal to about three microns from a closest edge of the perimeter edge of the aperture. In some implementations, the display apparatus can include a second sidewall positioned within the aperture substantially parallel to the first sidewall. In some implementations, the first sidewall can be at least partially curved away from the second sidewall.

In some implementations, the display apparatus can include a light blocking layer (LBL) disposed on the substrate including a LBL aperture defined through it. The LBL aperture can have a LBL perimeter edge. When the light blocking component is in a light blocking position with respect to light passing through the LBL aperture, the first sidewall can be positioned a distance away from the LBL perimeter edge in a direction parallel to the second axis that is greater than a height of a gap between the LBL and the first sidewall. In some implementations, at least one surface of the first sidewall can have a reflectance of greater than about 75%. In some implementations, the surface of the light blocking component can include a plurality of layers of material and the sidewall can include a fewer number of layers of material than the surface of the light blocking component.

In some implementations, the display apparatus can include a display including the display element. The display apparatus also can include a processor that is capable of communicating with the display, the processor being capable of processing image data. The display apparatus also can include a memory device that is capable of communicating with the processor.

In some implementations, the display apparatus can include a driver circuit capable of sending at least one signal to the display and a controller capable of sending at least a portion of the image data to the driver circuit. In some implementations, the display apparatus can include an image source module capable of sending the image data to the processor. The image source module can include a receiver, a transceiver, and/or a transmitter. In some implementations, the display apparatus can include an input device capable of receiving input data and communicating the input data to the processor.

Another innovative aspect of the subject matter described in this disclosure can be implemented in a method of forming a display apparatus. The method includes providing a mold over a substrate for portions of a light blocking component, and depositing a structural material over the mold such that the deposited structural material coats the exposed surfaces of the mold. The method includes patterning the structural material to define the light blocking component, a light blocking component aperture formed through a surface of the light blocking component that is substantially parallel to the substrate, and a first sidewall positioned within the aperture. The aperture includes a perimeter edge, a first axis, and a second axis. The first axis is longer than, and perpendicular to, the second axis. The first sidewall is spaced away from the perimeter edge of the aperture, extending substantially parallel to the first axis and oriented at least partially normal to the surface of the light blocking component. The method includes removing the mold.

In some implementations, patterning the structural material can include patterning the structural material to define the first sidewall such that the first sidewall is spaced less than or equal to about three microns from a closest edge of the perimeter edge of the aperture. In some implementations, patterning the structural material can include patterning the structural material to define a second sidewall positioned within the aperture substantially parallel to the first sidewall. In some implementations, patterning the structural can include includes patterning the structural material such that the first sidewall is at least partially curved away from the second sidewall.

In some implementations, the method can include depositing a light blocking layer (LBL) over the substrate prior to providing the mold and patterning the LBL to define an LBL aperture having a perimeter edge. In some implementations, providing the mold can include providing the mold such that a thickness of the mold is equal to the desired height of a gap between the LBL and the light blocking component. In some implementations, patterning the LBL to define the LBL aperture can include patterning the LBL to define the LBL aperture such that when the light blocking component is in a light blocking position with respect to light passing through the LBL aperture, the first sidewall is positioned a distance away from the LBL perimeter edge in a direction parallel to the second axis that is greater than the height of the gap between the LBL and the first sidewall.

In some implementations, the method can include selecting the structural material to have a reflectance of greater than about 75%. In some implementations, the method can include depositing additional layers of structural material and patterning the structural material such that the first sidewall includes a fewer number of layers of structural material than the surface of the light blocking component.

Another innovative aspect of the subject matter described in this disclosure can be implemented in a display apparatus. The display apparatus includes a light blocking means suspended over a substrate and capable of moving in a plane parallel to the substrate. The light blocking means includes a light transmitting means formed through a surface of the light blocking means that is substantially parallel to the substrate to allow light to pass through a portion of the light blocking means. The light transmitting means includes a perimeter edge. The display apparatus includes a light reflecting means positioned within the light transmitting means, spaced away from the perimeter edge and oriented at least partially normal to the surface of the light blocking means. In some implementations, the light reflecting means is spaced less than or equal to about three microns from a closest edge of the perimeter edge of the light transmitting means.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3A shows a perspective view of an example shutter-based light modulator incorporating integrated sidewall reflectors.

FIG. 3B shows a cross-sectional view of the example shutter-based light modulator of FIG. 3A in an open position.

FIG. 3C shows a cross-sectional view of the example shutter-based light modulator shown in FIG. 3A in a closed position.

FIG. 4 shows a flow diagram of an example process for manufacturing a shutter-based light modulator.

FIGS. 5A-5G show cross sectional views of stages of construction of an example display apparatus according to the manufacturing process shown in FIG. 4

FIGS. 6A-6C show cross sectional views of stages of construction of another example display apparatus according to the manufacturing process shown in FIG. 4.

FIG. 7 shows another example process for manufacturing a shutter-based light modulator.

FIGS. 8-16 show cross sectional views of several example alternative shutter-based light modulators.

FIGS. 17 and 18 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The light output profile of a display incorporating shutter-based light modulators with elongated apertures can be improved by integrating sidewall reflectors into one or more apertures formed in the shutter. The apertures have first and second axes. The first axis is longer than and is perpendicular to the second axis. The sidewall reflectors extend substantially parallel to the first, longer axis. With the shutter-based light modulator in an open state, light emitted by a backlight can pass directly through the light modulator, through the shutter aperture(s), without reflecting off of the sidewall reflectors, within a first range of angles with respect to the display normal. Additional light having a greater angle with respect to the display normal can still pass through the shutter-based light modulator by reflecting off of the sidewall reflectors. As a result, the total angular distribution of light emitted by the display through the shutter-based light modulator is broader than it would be without the sidewall reflectors.

In some implementations, the sidewall reflectors can be positioned away from the edges of the shutter apertures. For example, each sidewall reflector can be separated from its respective shutter aperture edge by a distance of about three microns or less. In some other implementations, the sidewall reflectors can extend directly from the edges of the shutter aperture. This arrangement of the sidewall reflectors allows for the largest possible separation of the sidewall reflectors along the second axis for a given shutter aperture size, which increases the range of light angles with respect to the display normal that can pass through the display along the second axis.

In some implementations, when the shutter is in a closed position with respect to an aperture formed in a light blocking layer beneath the shutter, the shutter can extend beyond the edge of the light blocking layer aperture. The shutter can be suspended above the aperture in the light blocking layer, and a light blocking portion of the shutter can extend beyond the edge of the light blocking layer aperture by a distance that is at least equal to the height of the shutter above the light blocking layer. Therefore, when the shutter is in the closed position, light passing through the aperture in the light blocking layer will be blocked by the light blocking portion of the shutter instead of possibly reflecting off of the surface of the sidewall reflector and out of the display.

Particular implementations of the subject matter described in this disclosure can be implemented to realize one or more of the following potential advantages. In some types of displays, apertures formed in display elements corresponding to pixels of the display can have an elongated shape. Because the apertures are longer along a first axis than along a second axis perpendicular to the first axis, light can be emitted through the apertures at a wider range of angles along the longer axis than along the shorter axis. Therefore, the viewing angle along the shorter axis can be smaller than along the longer axis. Incorporating sidewalls into the display element apertures can allow light from a wider range of angles along the second axis to pass through the apertures, thereby increasing the viewing angle along the shorter axis of the display. This improves the uniformity of light distribution for the display overall. Sidewall reflectors can extend along the length of the longer axis and can have reflective surfaces directed towards the middle of the display element. Light emitted by a backlight at relatively large angles that would otherwise be blocked by a front aperture layer can instead be reflected off of the sidewall reflectors and out of the display. The increased light output can result in wider viewing angles and increased display brightness.

In some implementations, shutters located within the display elements are capable of preventing light from reflecting off of the sidewall reflectors and out of the display when the shutter is in a closed position. The shutters can include an extended length that extends beyond the edge of apertures formed in a rear light blocking layer through which a backlight emits light. The length of the overlap can be selected to be greater than or equal to about the height of the shutter above the rear light blocking layer, so that substantially all of the light emitted through the rear apertures is prevented from reflecting off of the sidewall reflectors and out of the display when the shutter is closed.

In some implementations, the sidewall reflectors are spaced away from the edges of the shutter aperture. Fabrication of the shutter-based light modulators can be accomplished more easily when a gap is left between the sidewall reflectors and the edges of the shutter aperture. Such a process can be repeated more reliably, relative to a process that does not leave such a gap, which results in reduced cost and complexity associated with the manufacturing process used to build the shutter-based light modulators.

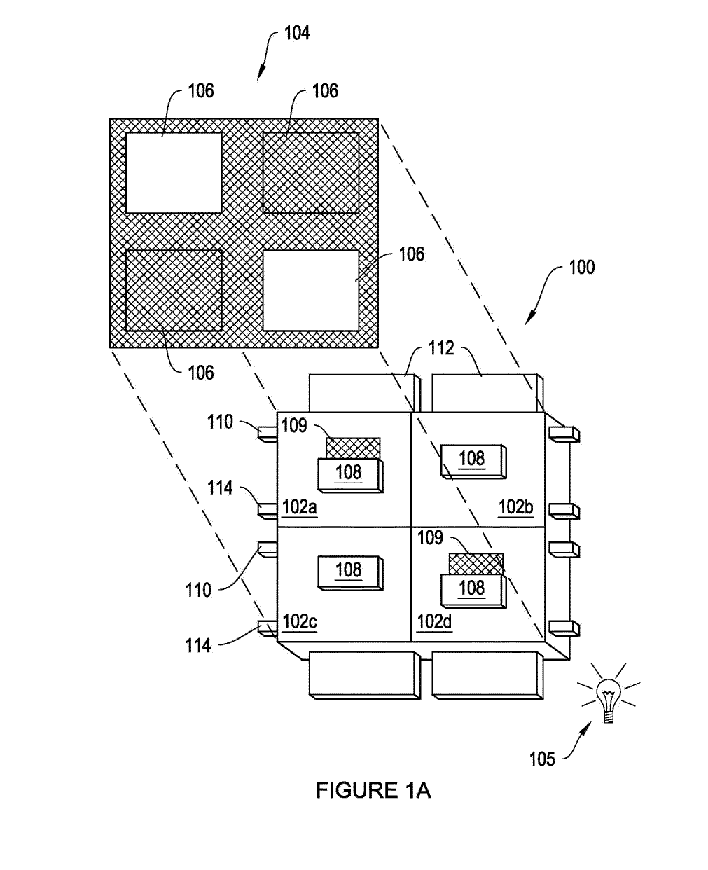

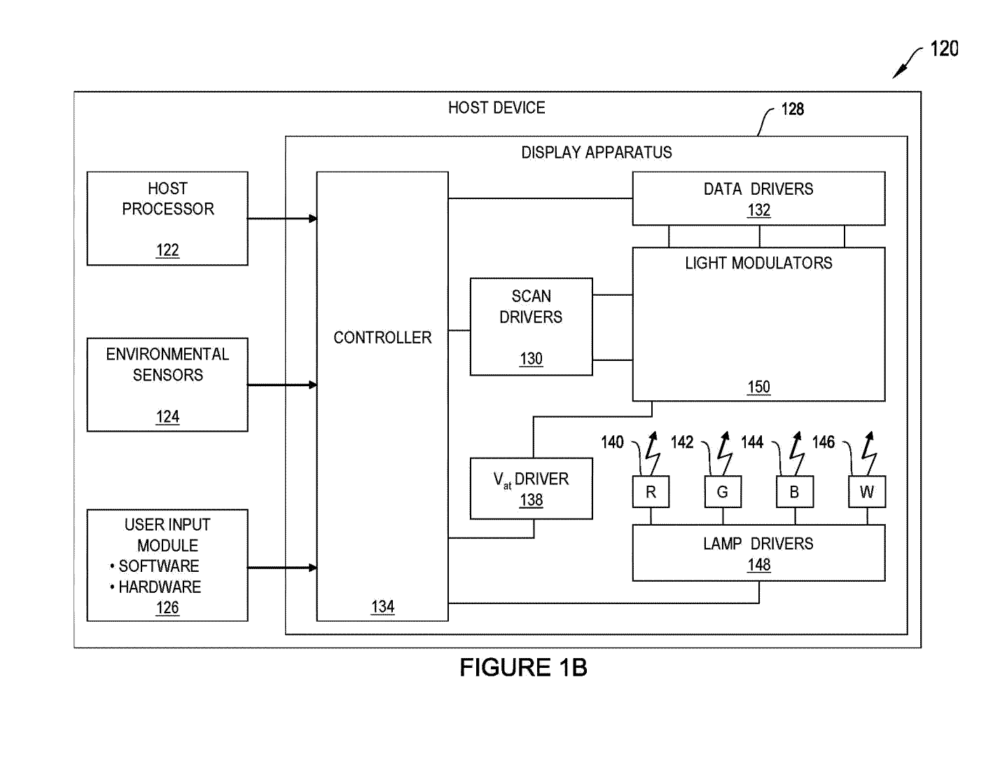

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are capable of providing analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are capable of applying only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations can be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from about 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

In some implementations the functionality of the controller 134 is divided between a microprocessor and a display controller integrated circuit. In some implementations, the display controller integrated circuit is implemented in an integrated circuit logic device, such as an application specific integrated circuit (ASIC). In some implementations, the microprocessor is capable of carrying out all or substantially all of the image processing functionality of the controller 134, as well as determining an appropriate output sequence for the display apparatus 128 to use to generate received images. For example, the microprocessor can be capable of converting image frames included in the received image data into a set of image subframes. Each image subframe is associated with a color and a weight, and includes desired states of each of the display elements in the array 150 of display elements. The microprocessor also can be capable of determining the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (e.g., the number of subframes, the order and timing of their output, and their weight implementation parameters for each subframe) can be collectively referred to as an “output sequence.”

In contrast, the display controller integrated circuit can be capable of carrying out more routine operations of the display apparatus 128. The operations may include retrieving image subframes from a frame buffer and outputting control signals to the scan drivers 130, the data drivers 132, the common drivers 138, and the lamp drivers 148, in response to the retrieved image subframe and the output sequence determined by the microprocessor. The frame buffer can be any volatile or non-volatile integrated circuit memory, such as dynamic random access memory (DRAM), high-speed cache memory, or flash memory. In some other implementations, the display controller integrated circuit causes the frame buffer to output data signals directly to the various drivers 130, 132, 138, and 148.

In some other implementations, the functionality of the microprocessor and the display controller integrated circuit described above are combined into a single logic device such as the controller 134, which may take the form of a microprocessor, an ASIC, a field programmable gate array (FPGA) or other programmable logic device. In some other implementations, the functionality of the microprocessor and the display controller integrated circuit may be divided in other ways between multiple logic devices, including one or more microprocessors, ASICs, FPGAs, digital signal processors (DSPs) or other logic devices.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

As described further below, the host processor 122 can forward instructions to the microprocessor to adjust its output sequence. For example, based on such instructions, the microprocessor can output images using output sequences with fewer or more subframes per color or with a higher or lower frame rate. In addition, based on instructions from the host processor 122, the microprocessor can adjust the relative intensity of each light source (such as red lamp 140, green lamp 142, blue lamp 144, and white lamp 146) in generating each primary color. Doing so adjusts the saturation of each primary color in order for the display apparatus 128 to be able to reproduce various color gamuts or portions of various color gamuts.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

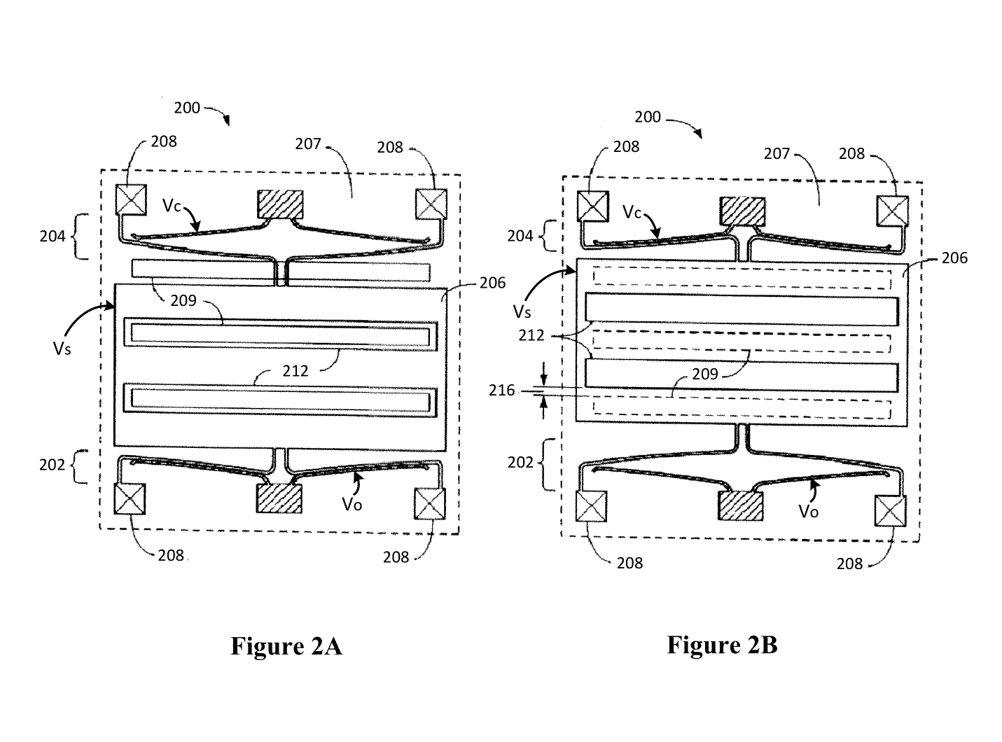

FIGS. 2A and 2B show views of an example shutter based light modulator 200. The light modulator (also referred to as “dual actuator shutter assembly”) 200 can include dual actuators for actuating a shutter. The dual actuator shutter assembly 200 can be suitable for incorporation into the direct view MEMS-based display apparatus 100 of FIG. 1A as the light modulator 102. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Both of the actuators 202 and 204 are compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. The inclusion of supports attached to both ends of the shutter 206 along its axis of movement reduces out of plane motion of the shutter 206 and confines the motion substantially to a plane parallel to the substrate. As will be described below, a variety of different control matrices may be used with the shutter assembly 200.

The shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In alternative implementations in which circular, elliptical, oval, or other curved apertures are formed in the aperture layer 207, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 212 and 209 in the open state, it is advantageous to provide a width or size for shutter apertures 212 which is larger than a corresponding width or size of apertures 209 in the aperture layer 207. In order to effectively block light from escaping in the closed state, it is preferable that the light blocking portions of the shutter 206 overlap the apertures 209. FIG. 2B shows an overlap 216, which in some implementations may be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

Generally, electrical bi-stability in electrostatic actuators, such as actuators 202 and 204, arises from the fact that the electrostatic force across an actuator is a strong function of position as well as voltage. The beams of the actuators in the light modulator 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, such as the light modulator 200, the equilibrium position of the light modulator will be determined by the combined effect of the voltage differences across each of the actuators. In other words, the electrical potentials of the three terminals, namely, the shutter open drive beam, the shutter close drive beam, and the load beams, as well as modulator position, are considered to determine the equilibrium forces on the modulator.

For an electrically bi-stable system, a set of logic rules can describe the stable states and can be used to develop reliable addressing or digital control schemes for a given light modulator. Referring to the shutter-based light modulator 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is only partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems an exceptional degree of bi-stability or hysteresis can be provided, with Vₘ existing over a range of about 2% and about 98% of Vₐₜ. In these systems, however, care must be taken to ensure that an electrode voltage condition of |V_{c}−Vₛ| or |Vₒ−Vₛ| being less than Vₘ can be reliably obtained within the addressing and actuation time available.

In some implementations, the first and second actuators of each light modulator are coupled to a latch or a drive circuit to ensure that the first and second states of the light modulator are the only two stable states that the light modulator can assume.

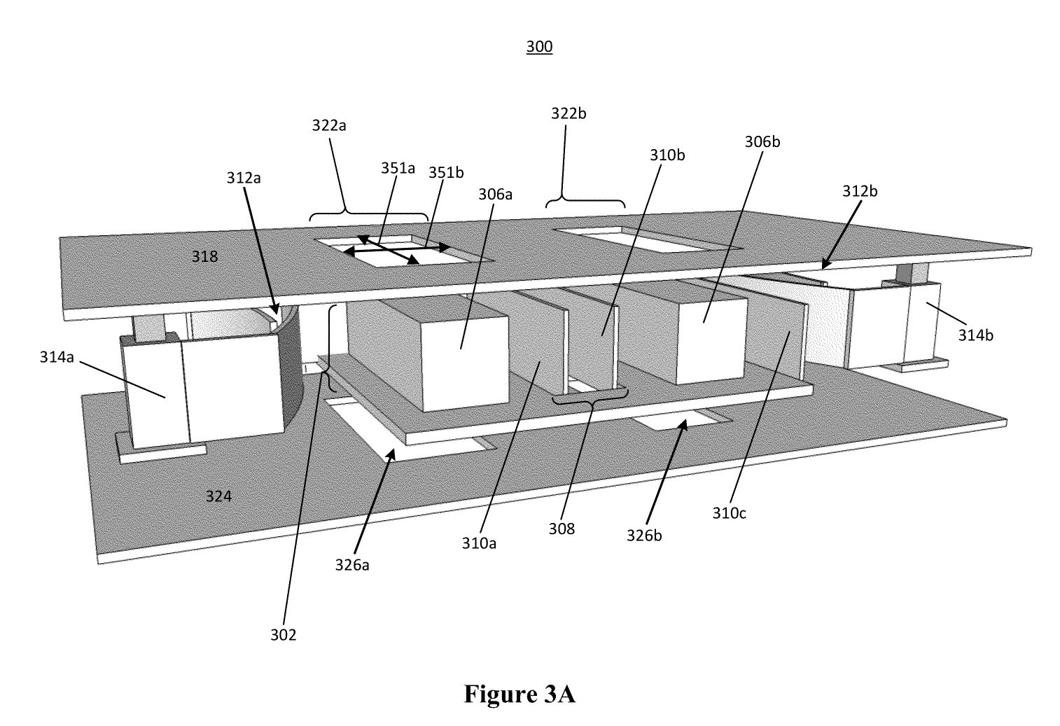

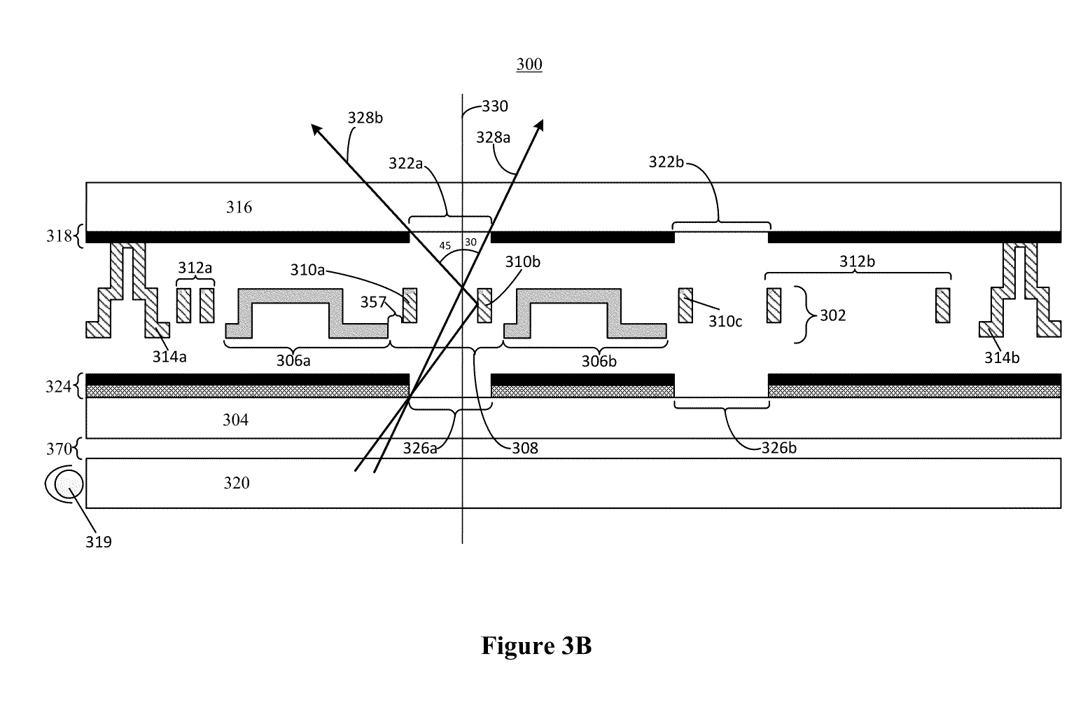

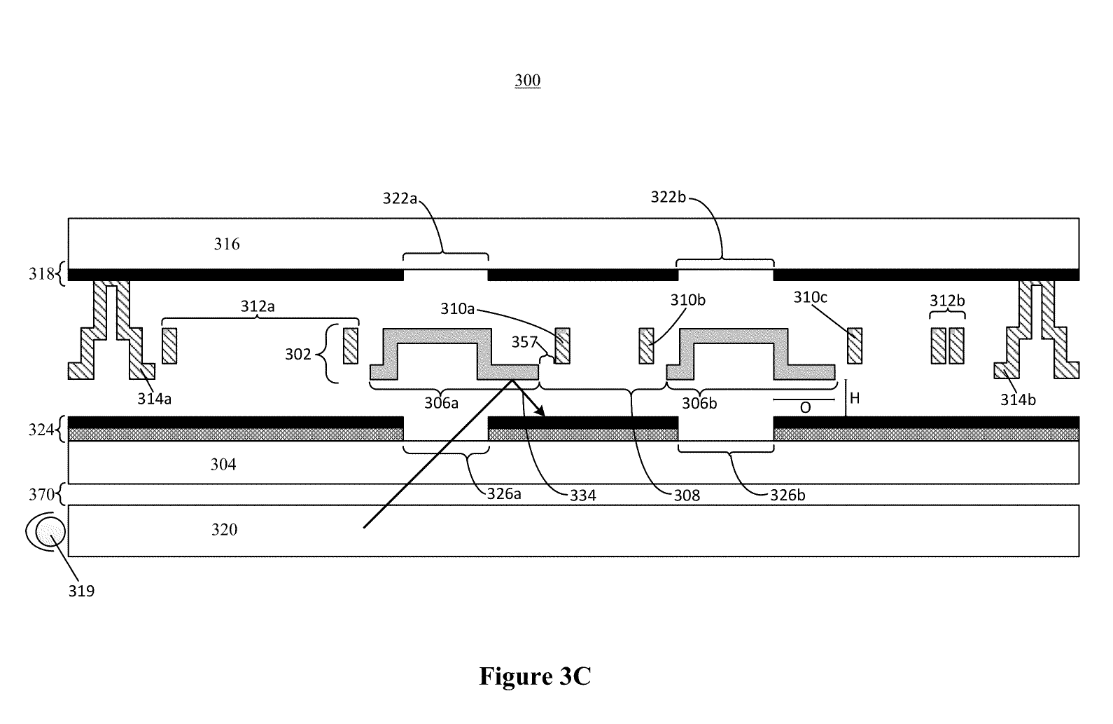

FIGS. 3A-3C show various views of an example shutter-based light modulator 300. FIG. 3A shows a perspective view of the shutter-based light modulator 300 in a closed position. The light modulator 300 is shown in a closed position in FIG. 3A. FIG. 3B shows a cross-sectional view of the example shutter-based light modulator 300 shown in FIG. 3A in an open position. FIG. 3C shows a cross-sectional view of the example shutter-based light modulator 300 shown in FIG. 3A in a closed position.

Referring to FIGS. 3A-3C, the shutter 302 is suspended between a front substrate 316 and a rear substrate 304 (shown in FIGS. 3B and 3C). The shutter 302 includes left and right light blocking portions 306a and 306b (generally referred to as light blocking portions 306), a shutter aperture 308, and sidewall reflectors 310a-310c (generally referred to as sidewall reflectors 310). A shutter close actuator 312a and a shutter open actuator 312b (generally referred to as actuators 312) are positioned adjacent to the left light blocking portion 306a and the right light blocking portion 306b, respectively. The actuators 312 are capable of moving the shutter 302 laterally into open and closed positions, in response to actuation voltages. Anchors 314a and 314b (generally referred to as anchors 314) couple to the front substrate 316 and support the actuators 314 and the light blocking portions 306 above the rear substrate 304.

A front aperture layer 318 couples to the front substrate 316 and defines two front apertures 322a and 322b (generally referred to as front apertures 322). A rear aperture layer 324 is positioned on the front-facing surface of the rear substrate 304. The rear aperture layer 324 defines two rear apertures 326a and 326b (generally referred to as rear apertures 326). When the shutter is in an open position, as shown in FIG. 3B, the front aperture 322a and the rear aperture 326a are aligned with the shutter aperture 308, while right light blocking portion 306b is positioned beside an optical path between the front aperture 322b and rear aperture 326b. A light source 319 and a light guide 320 (together forming a backlight) are positioned behind the rear substrate 304. The light guide 320 is separated from the rear substrate 304 by a gap 370. In some implementations, the gap 370 can be filled with air. In some other implementations, the gap 370 can be filled with another fluid or a vacuum. The fluid or vacuum filling the gap 370 can aid in extracting a desired angular distribution of light from the light guide 320.

As shown in FIG. 3A, the shutter aperture 308, rear apertures 326, and front apertures 322 of the shutter-based light modulator 300 are longer along a first axis 351a (extending parallel to the length of the sidewall reflectors 310) than along a second axis 351b, which is perpendicular to the first axis 351a. In some implementations, the shutter aperture 308, the rear apertures 326, and the front apertures 322 each have a length in the range of about 40 microns to about 150 microns, such as in the range of 60-80 microns, along the first axis 351a and a width in the range of about 5 microns to about 30 microns, such as in the range of 10-20 microns, along the second axis 351b. As a result, light can pass through the shutter-based light modulator 300 without reflecting off of any internal surfaces at a greater range of angles along the first axis 351a than along the second axis 351b. Images formed on a display incorporating the shutter-based light modulator 300 can therefore be viewed at a wider range of angles along the first axis 351a than along the second axis 351b. Wider viewing angles are often desirable for electronic displays. In addition, uniformity of viewing angles regardless of display orientation is also desirable. The sidewall reflectors 310 can be used to increase the viewing angle along the direction of the shorter second axis 351b to help achieve these goals.

As shown in the cross sectional views of FIGS. 3B and 3C, the sidewall reflectors 310 are separated from the light blocking portions 306 by narrow gaps, such as the gap 357. In some implementations, the gap 357 can have a width of less than about three microns. In the closed position, the light blocking portions 306a and 306b overlap the surface of the light blocking layer 324 by a distance at least equal to the height of the light blocking portion 306 above the light blocking layer 324 to prevent light from reflecting off of the sidewall reflectors 310, through the gap 357, and out through the front apertures 322.

In the open position shown in FIG. 3B, the shutter 302 can allow the light passing through the rear apertures 326a and 326b to continue to pass towards the front substrate 316. In some implementations, the shutter 302 can be moved to the open position by applying a voltage across the pair of electrode beams that form the shutter open actuator 312a.

The sidewall reflectors 310a and 310b are adjacent to the edges of the shutter aperture 308 and the front and rear apertures 322 and 326. For example, the sidewall reflectors 310a and 310b are positioned so that they extend along the edge of the shutter aperture 308 along the first axis 351a. The faces of the sidewall reflectors 310a and 310b are directed towards the middle of the shutter aperture 308. The sidewall reflectors 310a and 310b can be made of any materials. In some implementations, the sidewall reflectors 310 can be formed from a material that is substantially reflective or substantially refractive. For example, the sidewall reflectors 310a and 310b can include metal layers which can reflect substantially all light. Alternatively, the sidewall reflectors 310a and 310b can be formed from one or more dielectric materials, which may reflect some light impinging thereon and refract the remaining light. In some implementations, the reflectance of the sidewall reflectors 310 can be at least about 50%. In some other implementations, the reflectance of the sidewall reflectors 310 can be about at least 75%. In some implementations, the sidewall reflectors 310 can be slightly curved away from each other. The curvature of the sidewall reflectors 310 can help to prevent the sidewall reflectors 310 from buckling inwards towards each other if a compressive stress exists within the shutter-based light modulator 300, or if a gradient exists across the sidewall wall reflectors 310 and the light blocking portions 306, which may tend to cause the sidewall reflectors to buckle.

FIG. 3B shows two illustrative light rays, a direct passage light ray 328a and an indirect passage light ray 328b. The direct passage light ray 328a passes directly (i.e., without reflection) from the light guide 320 through the front aperture 322a in the front aperture layer 318. The direct passage light ray 328a represents a light ray having the greatest possible angle, with respect to the display normal 330, that can pass through the aperture 322a without reflecting off of a surface of the shutter-based light modulator 300. Although FIG. 3B shows this angle to be about 30°, other angles may be possible in some implementations. For example, in some other implementations, the maximum angle for a direct passage light ray can be about 35 degrees, about 40 degrees, or any other angle.

The indirect passage light ray 328b, on the other hand, passes from the light guide 320, through the rear aperture 326a in the light blocking layer 324, through the shutter aperture 308, off of the sidewall reflector 310b, and through the front aperture 322a formed in the front light blocking layer 318. As shown in FIG. 3B, the indirect passage light ray 328b has an angle with respect to the display normal 330 that is substantially larger than the maximum angle possible for a light ray that passes directly through the shutter-based light modulator 300 (i.e., about 45° with respect to the display normal 330, rather than about 30°). In some other implementations, other angles may be achieved for indirect passage light rays. Because light can escape through the front aperture 322a at a greater angle due to the sidewall reflectors 310, a display incorporating the shutter-based light modulator 300 can have a wider range of viewing angles along the second axis 351b.

The sidewall reflector 310c can serve a similar purpose to the sidewall reflectors 310a and 310b. For example, in the open position shown in FIG. 3B, the sidewall reflector 310c is adjacent to the edge of the front and rear apertures 322b and 326b. Light passing from the light guide 320 through the rear aperture 326b can reflect off of the sidewall reflector 310c before escaping from the shutter based-based light modulator through the front aperture 322b such that light can have a greater angle with respect to the display normal 330 than would be possible for light to pass through the front and rear apertures 322b and 326b without such a reflection. In some implementations, the leftmost electrode beam of the electrostatic actuator 312b also can serve as a sidewall reflector to increase the angle at which light passes through the front aperture 322b.

FIG. 3C shows the shutter-based light modulator of FIG. 3A with the shutter 302 in a closed position. In some implementations, the shutter 302 can be moved into the closed position by applying an actuation voltage across the shutter close actuator 312b. The force created by the resulting electric field can draw the leftmost electrode beam of the shutter close actuator 312b towards its rightmost electrode beam, pulling the light blocking portions 306a and 306b into a position substantially between the respective front and rear apertures 322 and 326.

In the closed position shown in FIG. 3C, the light blocking portions 306 of the shutter 302 are positioned such that no direct light rays can pass from the light guide 320 through the aperture 322a. Instead, these light rays will be absorbed by or reflected off of the light blocking portions 306 of the shutter 302. Reflected light is then directed towards the rear of the device where it will be absorbed by the light blocking layer 324.

Furthermore, in some implementations, the light blocking portions 306 of the shutter 302 are capable of preventing light passing through the apertures 326 from reflecting off of the sidewall reflectors and through the apertures 322 while the shutter 302 is in the closed position. For example, the light blocking portions 306 can extend well beyond the edge of the apertures 326 to overlap portions the light blocking layer 324. The overlap distance, shown as “O” in FIG. 3C, can be selected to be greater than or equal to the height, shown as “H” in FIG. 3C, of the light blocking portions 306 above the light blocking layer 324. Maintaining such a relative dimensional relationship can ensure that light passing through the rear apertures 326 will not reach and reflect off of the sidewall reflectors 310 and escape through the front apertures 322 while the shutter 302 is in the closed position. This effect is illustrated by the light ray 334 in FIG. 3C. The light ray 334 passes from the light guide 320 through the aperture 326a at an angle that is directed towards the sidewall reflector 310a. However, because the overlap of the light blocking portion 306a is greater than the height of the light blocking layer 324, the light ray 334 contacts the light blocking portion 306a and is reflected away from the sidewall reflector 310a. The light blocking portion 306b also includes an extended overlap portion to prevent light from reflecting off of the sidewall reflector 310c when the shutter 302 is in the closed position.

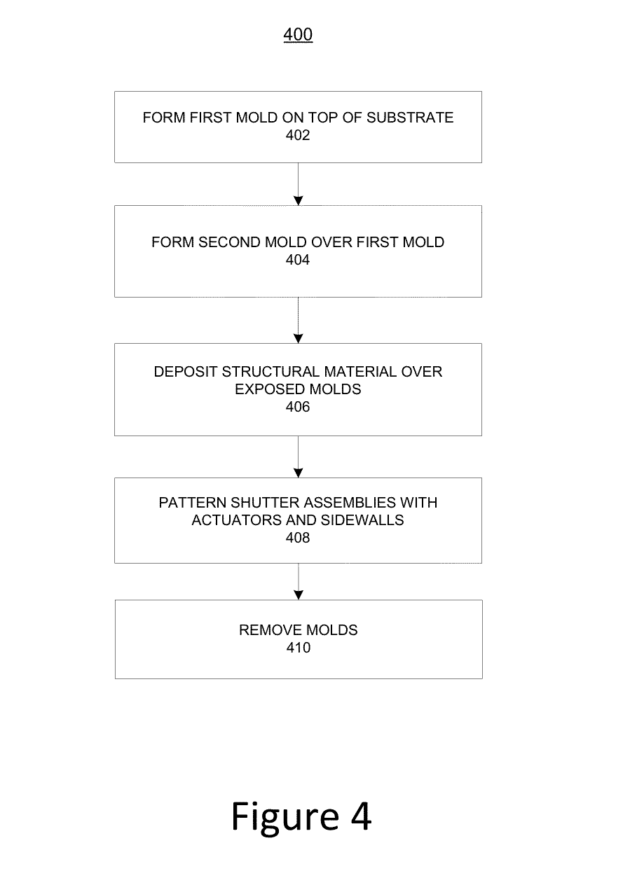

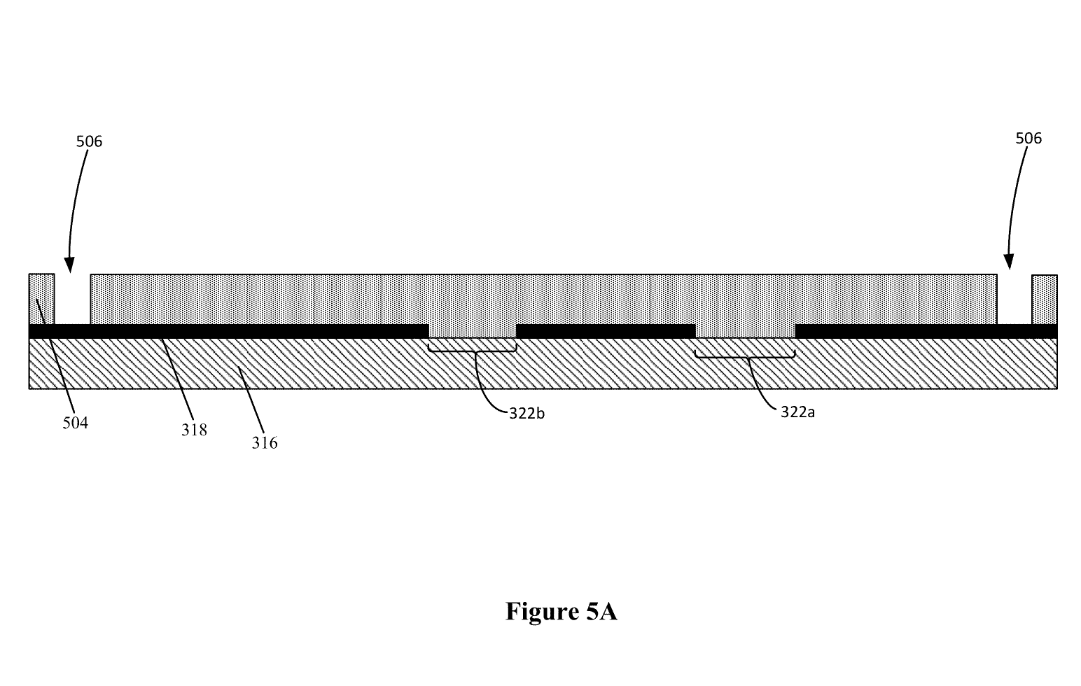

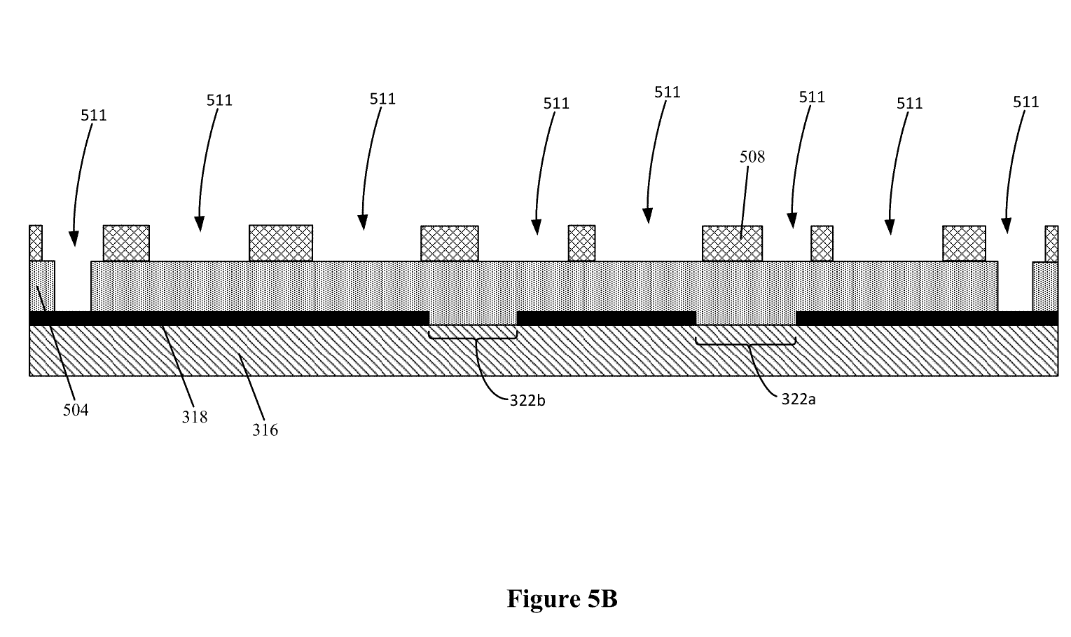

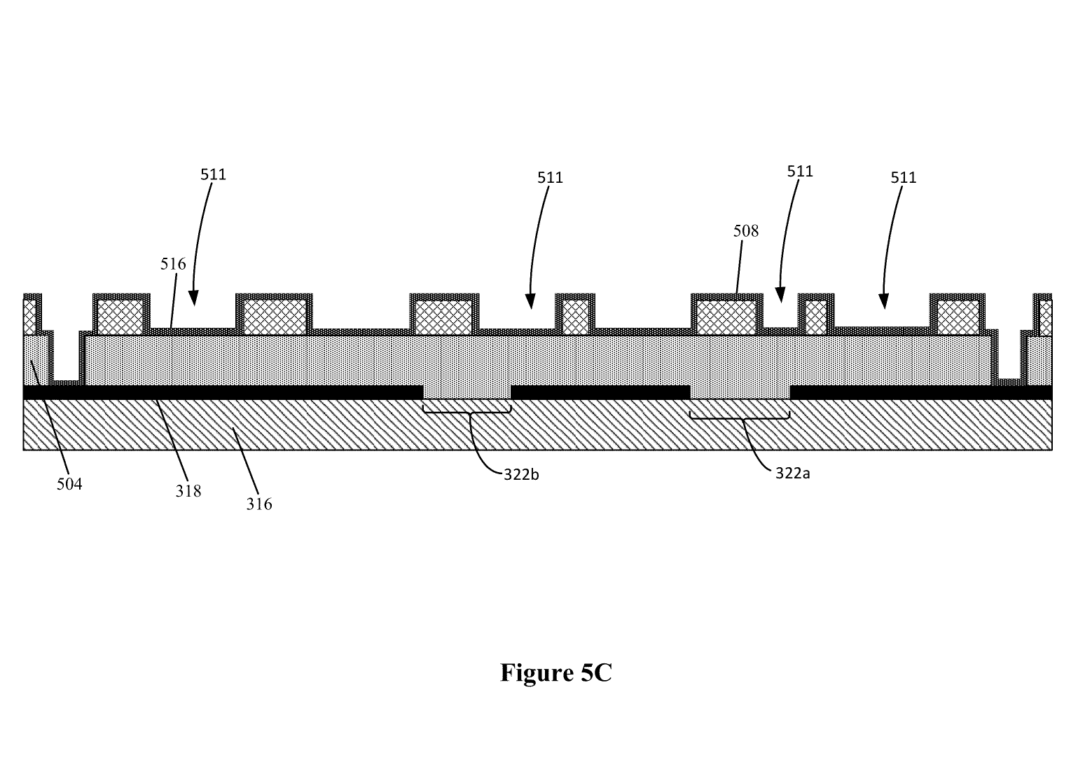

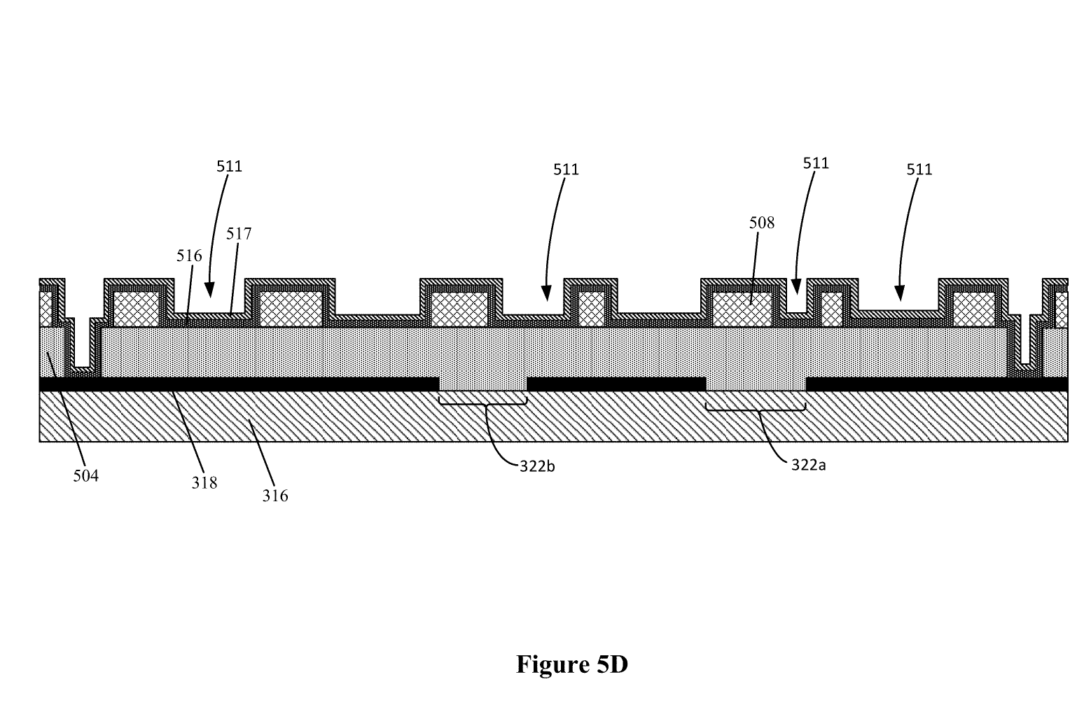

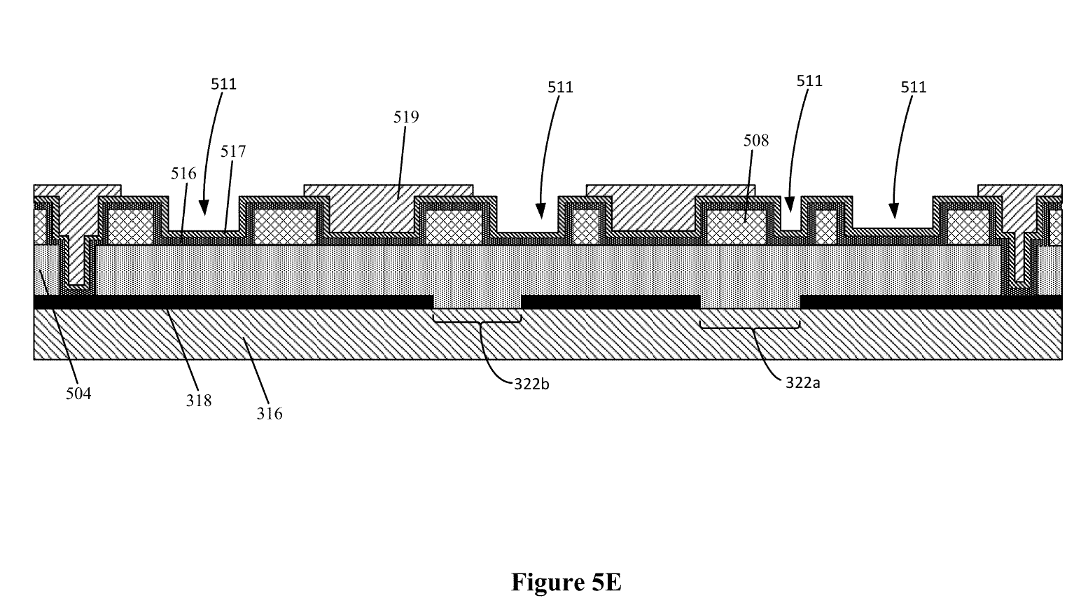

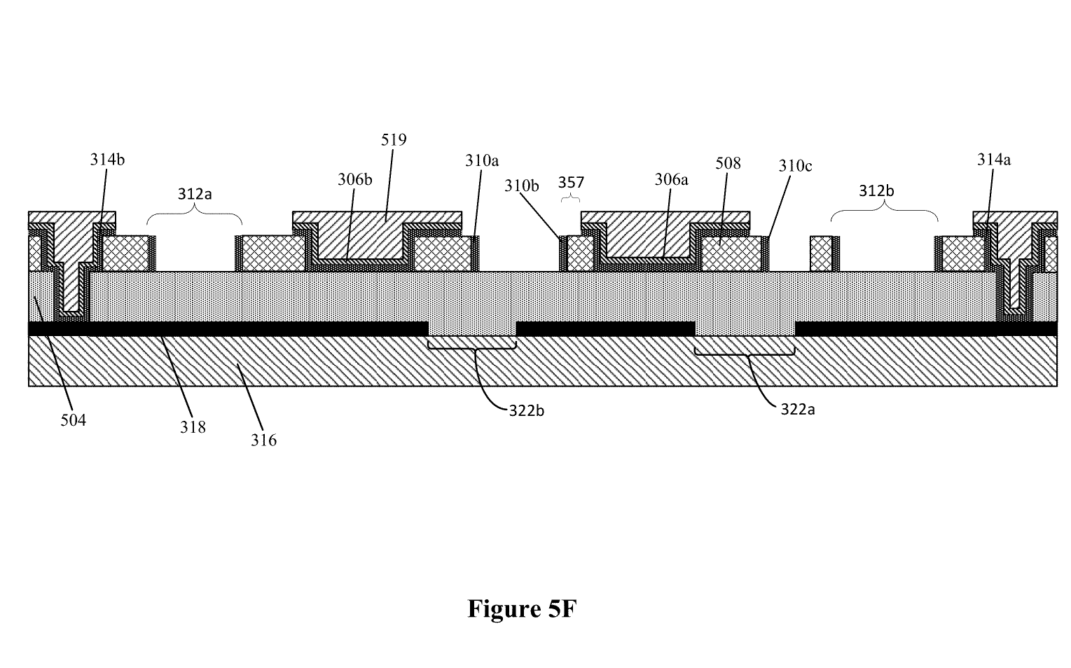

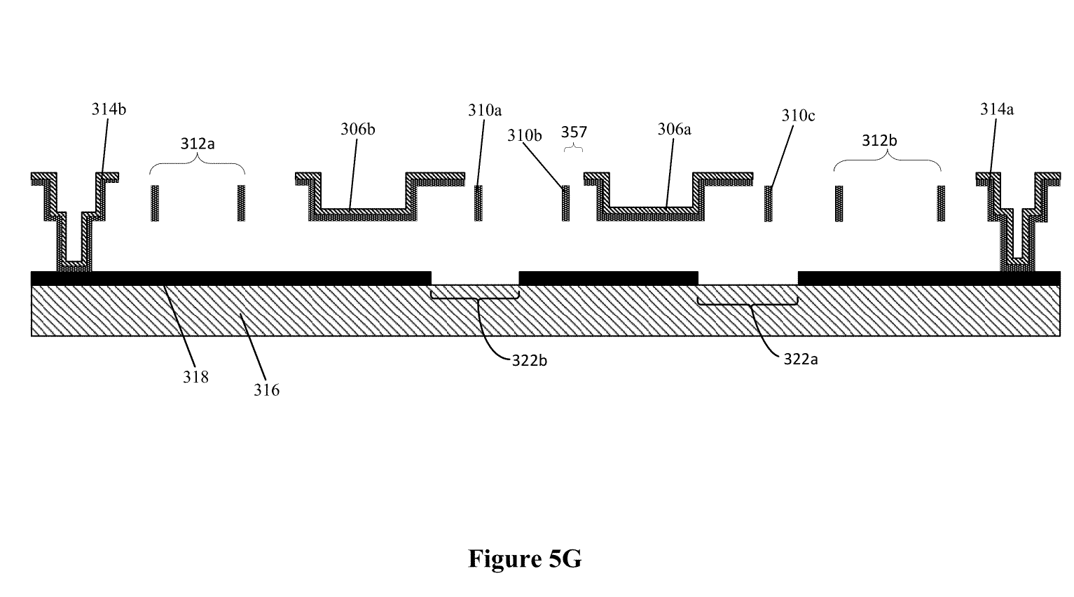

FIG. 4 shows flow diagram of an example process 400 for manufacturing a display apparatus. For example, the process 400 can be used to manufacture the shutter-based light modulator 300 shown in FIG. 3A-3C. In brief, the process 400 includes forming a first mold on top of a substrate (stage 402). A second mold is formed over the first mold (stage 404). Structural material is deposited over the exposed molds (stage 406). Next, a plurality of shutters, with associated actuators and sidewall reflectors are patterned and etched (stage 408). The molds are then released (stage 410). Each of these process stages as well as further aspects of the manufacturing process 400 are described below in relation to FIGS. 5A-5G.

FIGS. 5A-5G show cross-sectional views of stages of construction of an example display apparatus according to the manufacturing process 400 shown in FIG. 4. This process yields a shutter assembly formed on a substrate that includes sidewall reflectors for allowing light to escape from the display apparatus at a wider range of angles. In the process shown in FIGS. 5A-5G, the display apparatus is fabricated on a mold made from a sacrificial material. The display apparatus shown being fabricated in FIGS. 5A-5G corresponds to the shutter-based light modulator 300 shown in FIG. 3A.

Referring to FIGS. 3A-3C, 4 and 5A-5G, the process 400 for forming the shutter-based light modulator 300 begins, as shown in FIG. 5A, with the formation of a first mold portion on top of a substrate (stage 402). The first mold portion is formed by depositing and patterning a first sacrificial material 504 on top of a light blocking layer 318 previously formed on an underlying substrate 316. The first layer of sacrificial material 504 can be or can include polyimide, polyamide, fluoropolymer, benzocyclobutene, polyphenylquinoxylene, parylene, polynorbornene, polyvinyl acetate, polyvinyl ethylene, and phenolic or novolac resins, or any of the other materials identified herein as suitable for use as a sacrificial material. Depending on the material selected for use as the first layer of sacrificial material 504, the first layer of sacrificial material 504 can be patterned using a variety of photolithographic techniques and processes such as by direct photo-patterning (for photosensitive sacrificial materials) or chemical or plasma etching through a mask formed from a photolithographically patterned resist. The pattern defined in the first sacrificial material 504 creates recesses 506 within which the anchors for the shutter-based display apparatus will eventually be formed. Additional layers, including layers of material forming a display control matrix may be deposited below the light blocking layer 318 and/or between the light blocking layer 318 and the first sacrificial material 504. The light blocking layer 318 defines front apertures 322a and 322b. In some implementations, the front apertures 322a and 322b are formed by a patterning or etching process that takes place prior to the deposition of the sacrificial material 504.

The process of forming the display apparatus continues with forming a second mold portion (stage 404). The second mold portion is formed from depositing and patterning a second sacrificial material 508 on top of the first mold portion formed from the first sacrificial material 504. The second sacrificial material can be the same type of material as the first sacrificial material 504, or can be a different sacrificial material with different properties.

FIG. 5B shows the shape of the mold, including the first and second mold portions, after the patterning of the second sacrificial material 508. The second sacrificial material 508 has been patterned to form recesses 510 to expose the recesses 506 formed in the first sacrificial material 504. The recesses 510 are wider than the recesses 506 such that a step like structure is formed in the mold 599. The mold 599 also is patterned to form recesses 511. The recesses 511 are formed to provide sidewalls upon which vertical structural features of the shutter-based light modulator 300 such as the sidewall reflectors 310a-310c can be formed, as described further below.

The process of forming the display apparatus 400 continues with the deposition of structural material over the exposed mold (stage 406), as shown in FIGS. 5C and 5D. A first layer of structural material 516 is deposited onto the exposed surfaces of the mold, as shown in FIG. 5C, followed by deposition of a second layer of structural material 517, as shown in FIG. 5D. In some implementations, the structural materials 516 and 517 are deposited in a chemical vapor deposition (CVD) process or a plasma-enhanced CVD (PECVD) process. In some implementations, the first structural material 516 can include one or more layers of amorphous silicon (Si). The second structural material can include metals, such as aluminum (Al), copper (Cu), nickel (Ni), chromium (Cr), molybdenum (Mo), titanium (Ti), tantalum (Ta), niobium (Nb), neodymium (Nd), or alloys thereof; dielectric materials such as aluminum oxide (Al₂O₃), silicon dioxide (SiO₂), tantalum pentoxide (Ta₂O₅), or silicon nitride (Si₃N₄); or semiconducting materials such as diamond-like carbon, Si, germanium (Ge), gallium arsenide (GaAs), cadmium telluride (CdTe) or alloys and compounds thereof. In some implementations, the structural materials 516 and 517 are deposited to a thickness of between about 0.1 microns and about two microns. In some implementations, an additional reflective layer is deposited on top of the other structural materials 516 and 517. The reflective material can be or can include a highly reflective metal, such as conformal Al.

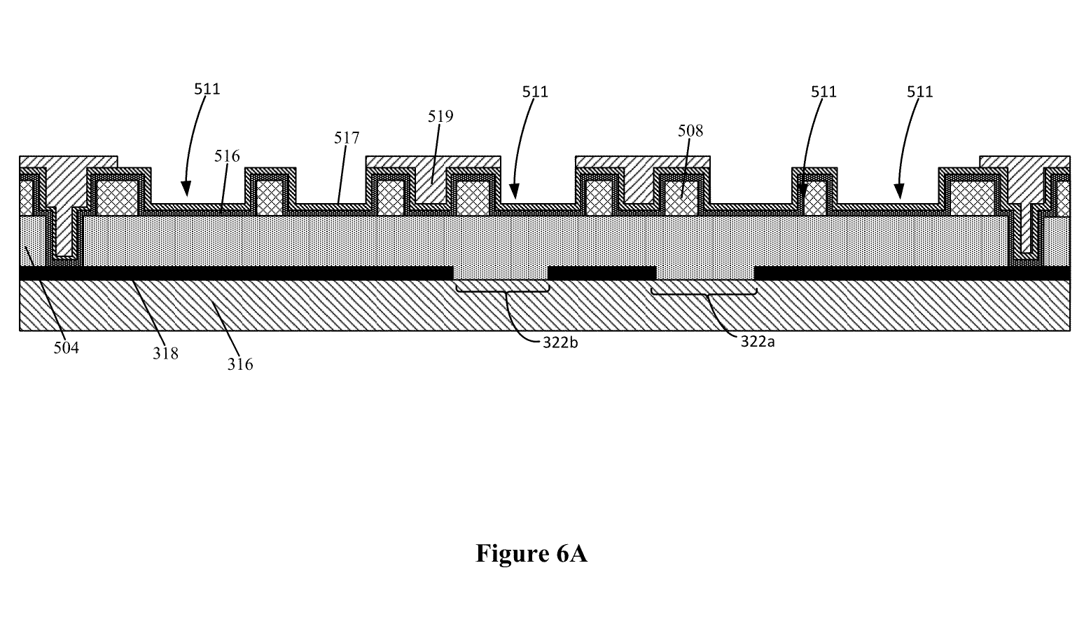

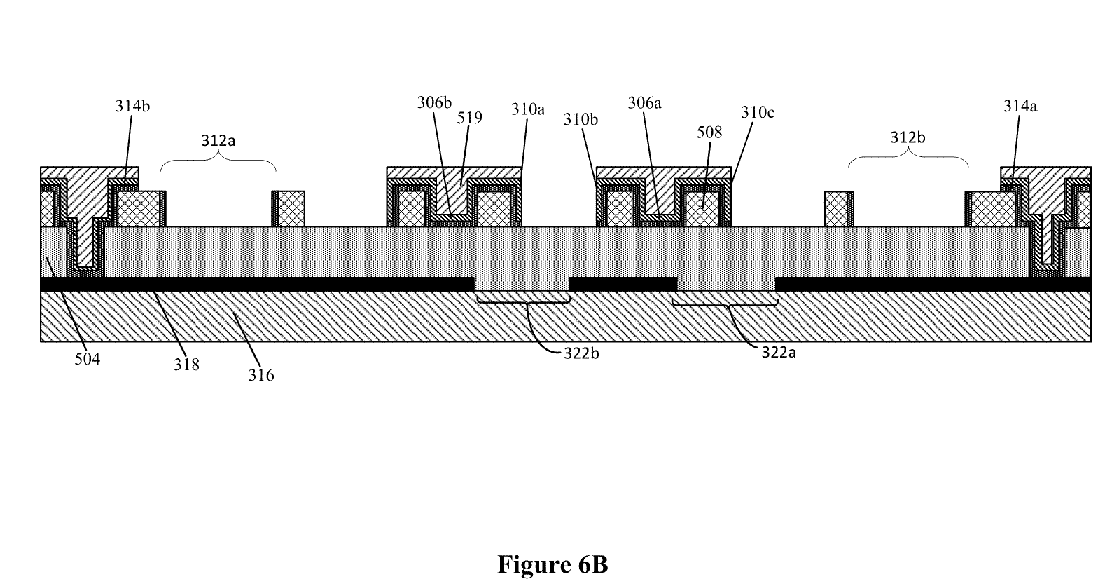

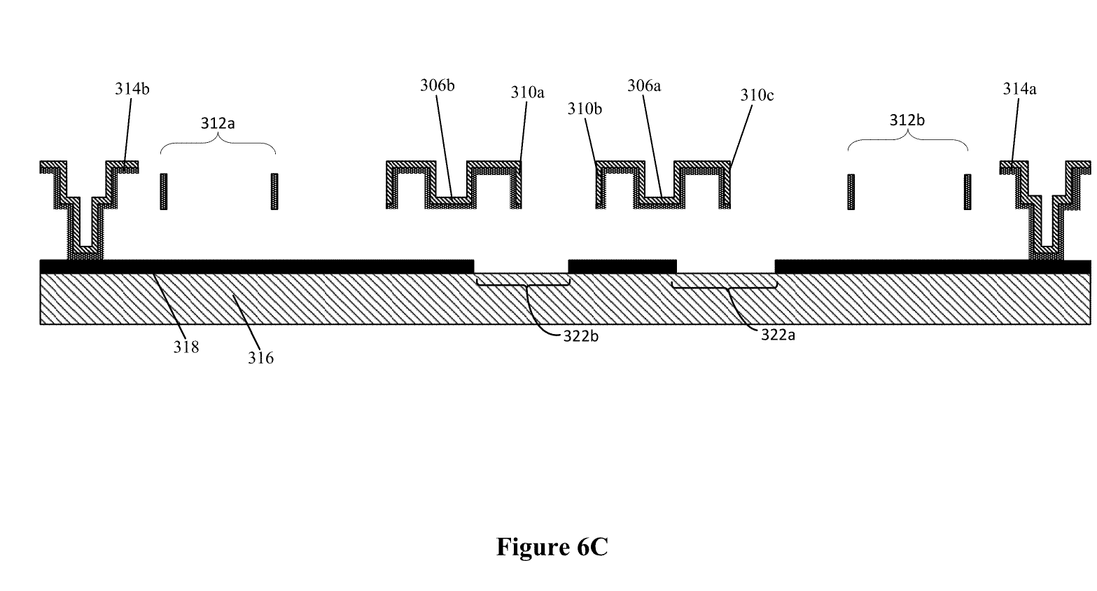

After deposition, the structural materials 516 and 517 are patterned (stage 408), as shown in FIG. 5E. First, a photoresist mask 519 is deposited on the second structural material 517. The photoresist 519 is then patterned. The pattern developed into the photoresist is designed such that, after a subsequent etch stage, the remaining structural materials 516 and 517 form the light blocking portions 306a and 306b of a shutter, along with sidewall reflectors 310a, 310b, and 310c and actuators 312a and 312b. To create the sidewall reflectors 310 and actuators 312, the photoresist 519 may be patterned to remove the photoresist 519 in regions on either side of the edges of the recesses 511 that will form the sidewall reflectors 310 and actuators 312, so that the photo-defined edges of the resist are at the top of the mold rather than at the bottom. Doing so helps ensure no extraneous shutter material remains at the bottom of the recess 511. Given the resolution of the patterning process, achieving this goal only by removing photoresist covering the bottom of the recesses 511, often yields an imperfect result. For example, attempting to remove the photoresist only from the bottom surfaces of the recesses 511 may result in a small amount of photoresist remaining in the recesses at the edges that will become the sidewall reflectors. Therefore, in a subsequent etching stage, an extraneous lip extending into the shutter aperture may remain on the light blocking portions of the shutter, which undesirably decreases the size of the shutter aperture. To avoid this result, in the cross sectional view shown in FIG. 5F, the sidewall reflectors 310 and actuators 312 adjacent to the light blocking portions 306 are separated from the light blocking portions 306 by a narrow gap 357. In other implementations, the sidewall reflectors 310 and actuators 312 may be directly adjacent to the light blocking portions 306. An example of such an implementation is shown in FIGS. 6A-6C. The etch of the structural materials 516 and 517 can be an anisotropic etch carried out in a plasma atmosphere with a voltage bias applied to the substrate, or to an electrode in proximity to the substrate. Alternatively, the etch of the structural materials 516 and 517 can be an isotropic etch or a combination of anisotropic and isotropic etches. In some implementations, the light blocking portions 306a and 306b, the sidewall reflectors 310, and actuators 312 can be formed using multiple patterning and etching steps.

Once the structural components of the display apparatus are formed (stage 408), the mold is removed (stage 410). The result, shown in FIG. 5G, includes the light blocking portions 306 of the shutter 302, the actuators 312, and the sidewall reflectors 310. The shutter 302 is positioned in a neutral position between the open position shown in FIG. 3A and the closed position shown in FIG. 3B. In some implementations, the mold is removed using standard MEMS release methodologies, including, for example, exposing the mold to an oxygen plasma, wet chemical etching, or vapor phase etching.

FIGS. 6A-6C show cross sectional views of stages of construction of another example display apparatus according to the manufacturing process shown in FIG. 4. FIGS. 6A and 6B show an alternative patterning technique corresponding to stage 408 of the process 400. Rather than patterning the photoresist mask 519 to leave a gap between the light blocking portions 306 and the sidewall reflectors 310 and actuators 310, the photoresist 519 is patterned to fully cover the light blocking portions 306 such that they extend substantially to the edge of sidewall reflectors 310 and the actuators 312. The structural materials 516 and 517 are then etched to form the sidewall reflectors 310, actuators 312, anchors 314, and light blocking components 306 of the shutter 302. In some implementations, the sidewall reflectors 310, actuators 312, anchors 314, and light blocking components 306 of the shutter 302 can be formed through a series of multiple patterning and etching steps. The mold is then removed (stage 410), and the resulting shutter-based light modulator is shown in FIG. 6C. As shown in FIG. 6C, there is no lateral space between the edges of the light blocking portions 306 and the sidewall reflectors 310 and actuators 312.

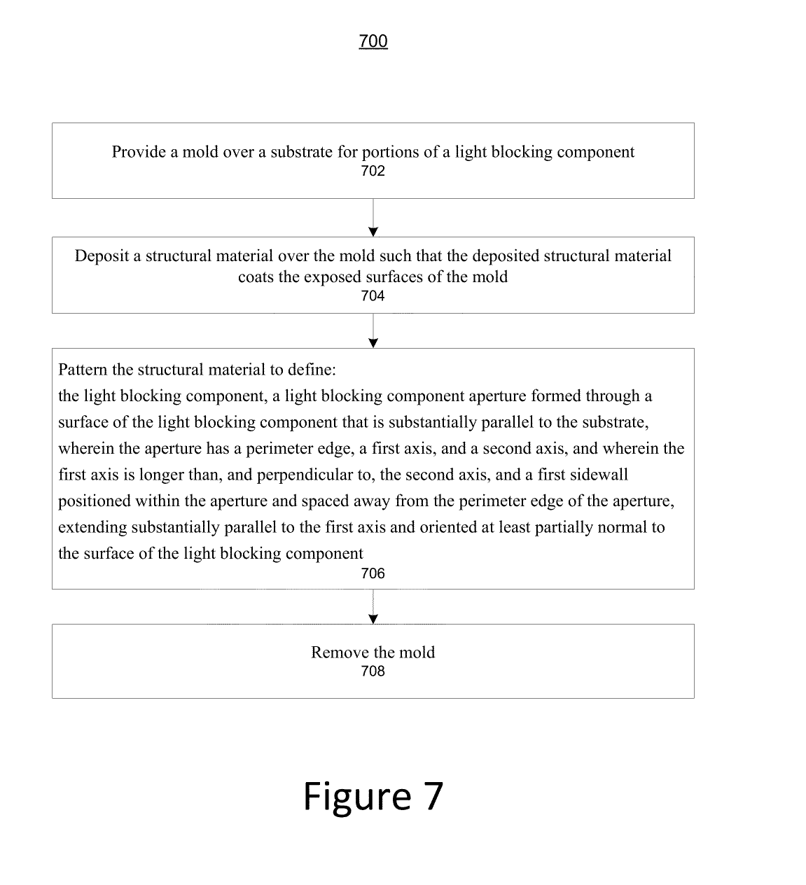

FIG. 7 shows another example process 700 for manufacturing a shutter-based light modulator. The process 700 includes providing a mold over a substrate for portions of a light blocking component (stage 702). The process 700 includes depositing a structural material over the mold such that the deposited structural material coats the exposed surfaces of the mold (stage 704). The process 700 includes patterning the structural material to define the light blocking component; a light blocking component aperture formed through a surface of the light blocking component that is substantially parallel to the substrate, wherein the aperture has a perimeter edge, a first axis, and a second axis, and wherein the first axis is longer than, and perpendicular to, the second axis; and a first sidewall positioned within the aperture and spaced away from the perimeter edge of the aperture, extending substantially parallel to the first axis and oriented at least partially normal to the surface of the light blocking component (stage 706). The process 700 also includes removing the mold (stage 708).

In some implementations, the stages of the process 700 are similar to the stages of the process 400 shown in FIG. 4. For example, stage 702 of the process 700 corresponds to stages 402 and 404 of the process 400; stage 706 of the process 700 corresponds to stage 406 of the process 400; stage 708 of the process 700 correspond to stage 408 of the process 400; and stage 710 of the process 700 corresponds to stage 410 of the process 400.

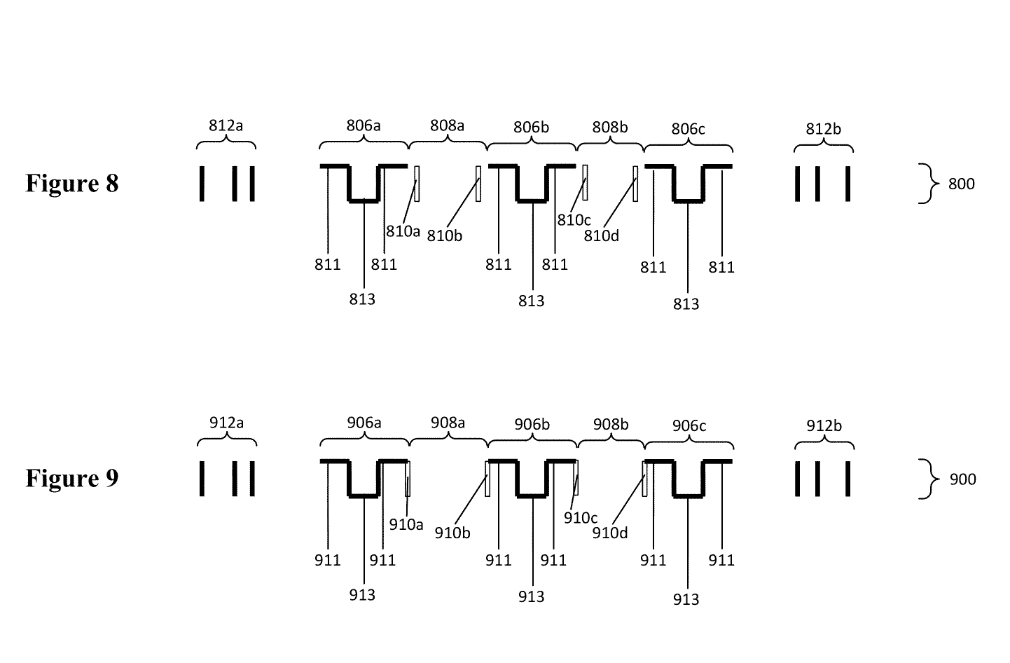

FIGS. 8-16 show cross sectional views of several example alternative shutter-based light modulators. The light modulators shown in FIGS. 8-16 vary with respect to the shape of the shutters and the position of the sidewall reflectors. The light blocking portions of the shutters, as well as the electrostatic actuators, are shown in black, while the sidewall reflectors are shown in white.

The light modulators shown in FIG. 8-16 include structural components that are substantially horizontal and substantially vertical, resulting in rectangular depressions when viewed in cross section. Each light modulator includes three light blocking portions arranged evenly between left and right actuators.

The light modulator 800 shown in FIG. 8 has light blocking portions 806a-806c with central rectangular depressions 813 and horizontal portions 811 extending outward on each side from the top of the rectangular depression 813. Sidewall reflectors 810a-810d (generally referred to as sidewall reflectors 810) are positioned on all edges that are not adjacent to the actuators 812a and 812b. The sidewall reflectors 810 of the light modulator 800 are separated from the light blocking portions 806 by narrow gaps, similar to the light modulator 300 shown in FIG. 3A. The gaps between the light blocking portions 806 and the sidewall reflectors 810 can help to facilitate the manufacturing process, as described above in connection with FIGS. 4 and 5A-5G.

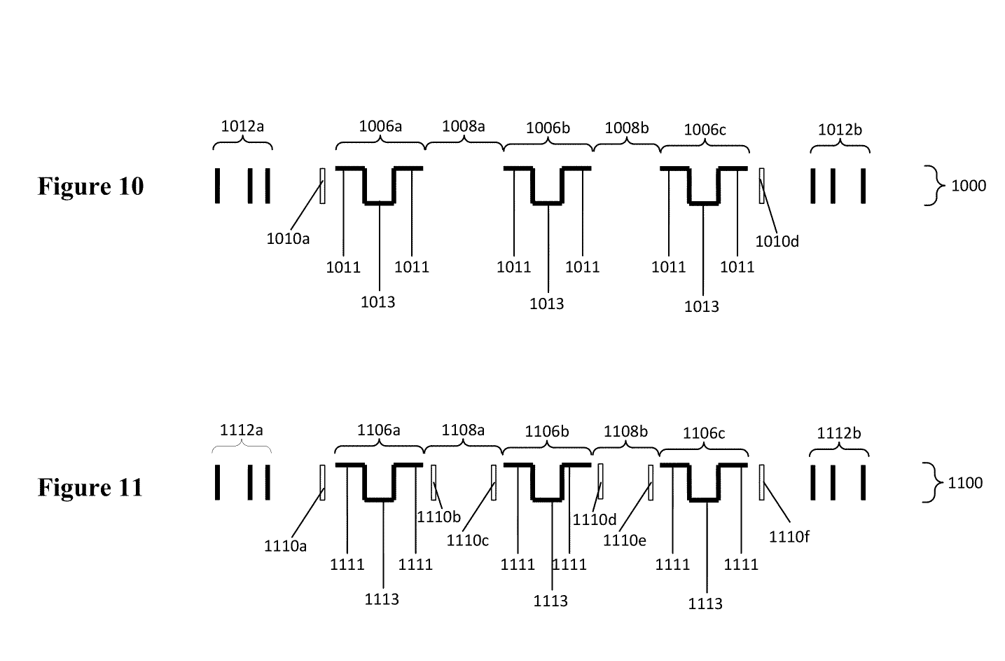

The light modulator 900 shown in FIG. 9 is similar to the light modulator 800 shown in FIG. 8, except that the sidewall reflectors 910a-910d are not separated from the light blocking portions 906 of the shutter. Horizontal portions 911 extend outward from the top of the rectangular depressions 913. A manufacturing process that can achieve this type of light modulator is described above in connection with FIGS. 6A-6C. The light modulator 1000 shown in FIG. 10 has light blocking components 1006 with central rectangular depressions 1013 and horizontal portions 1011, similar to the light blocking components 806 shown in FIG. 8. However, sidewall reflectors 1010a and 1010b are only positioned on the edges of the light blocking portions that are adjacent to the actuation electrodes. The sidewall reflectors 1010 are spaced away from the edges of light blocking components 1006.

The light modulator 1100 shown in FIG. 11 has light blocking portions 1106 with central rectangular depressions 1113, horizontal portions 1111, and sidewall reflectors 1110a-1110f (generally referred to as sidewall reflectors 1110). The sidewall reflectors 1110 are separated from the light blocking portions 1106 by gaps. The sidewall reflectors 1110 are located on all sides of each light blocking portion 1106. The light modulator 1200 shown in FIG. 12 also has light blocking portions 1206 with central rectangular depressions 1213 and horizontal portions 1211. The sidewall reflectors 1210 are located on all sides of the light blocking portions 1206. The sidewall reflectors 1210a and 1210f, which are adjacent to the actuators 1212a and 1212b, respectively, are separated from the light blocking components 1206a and 1206c by gaps. The remaining sidewall reflectors 1210b-1210d are positioned directly along the edges of the light blocking portions 1206.

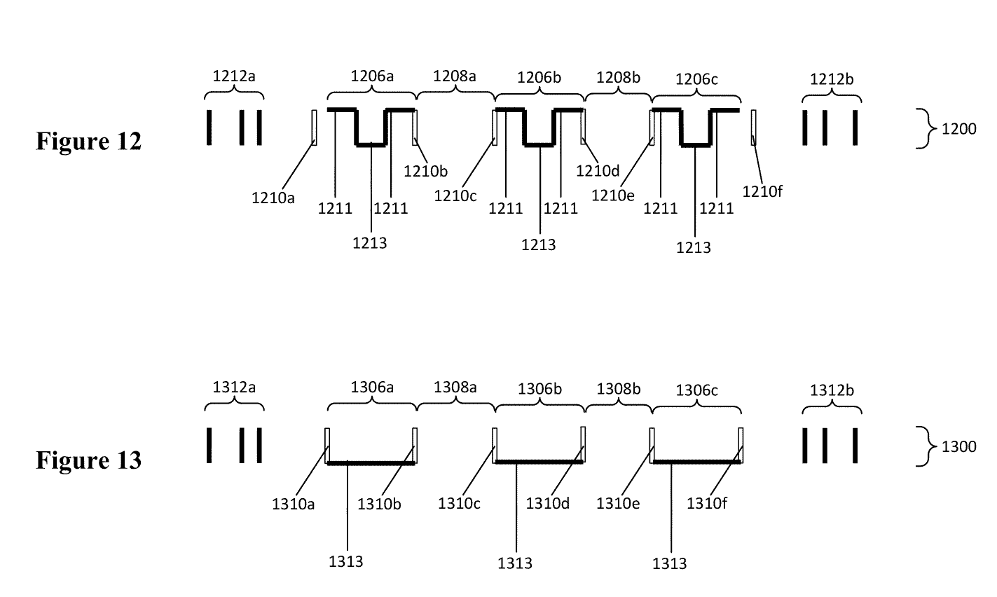

The light modulator 1300 shown in FIG. 13 has three light blocking portions 1306a-1306c, each of which includes a rectangular depression 1313 extending along its entire width. The sidewall reflectors 1310 are positioned on both edges of each light blocking portion 1306 and are not separated by gaps from the light blocking portions 1306. The light modulator 1400 shown in FIG. 14 includes a central light blocking portion 1406b having a rectangular depression 1413b extending along its entire width. Two additional light blocking portions 1406a and 1406c include rectangular depressions 1413a and 1413c offset from their centers, as well as horizontal portions 1411a and 1411c extending towards the actuators 1412a and 1412b, respectively. Sidewall reflectors 1410 are positioned on all edges of the light blocking portions 1406 that are not adjacent to the actuators 1412a and 1412b.

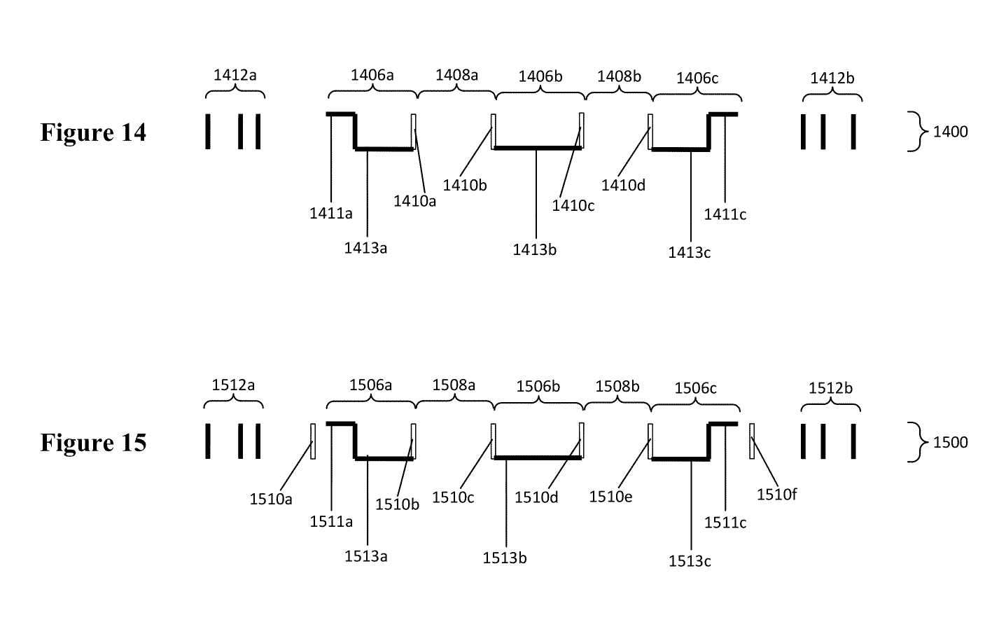

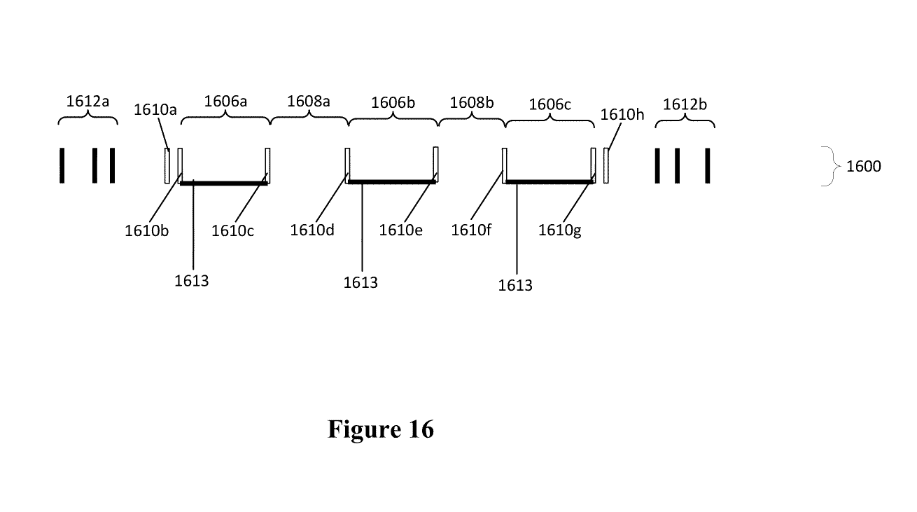

The light modulator 1500 shown in FIG. 15 includes a central light blocking portion 1506b having a rectangular depression 1513b extending along its entire width. Two additional light blocking portions 1506a and 1506c include rectangular depressions 1513a and 1513c offset from their centers, as well as horizontal portions 1511a and 1511b extending outwards toward the actuators 1512a and 1512b, respectively. Sidewall reflectors 1510 are positioned on all edges of the light blocking portions 1506 including the edges that are adjacent to the actuators 1512a and 1512b. The sidewall reflectors 1510a and 1510f are separated from the light blocking portions 1506a and 1506c by gaps, while the remaining sidewall reflectors 1510b-1510e are positioned directly along the light blocking portions 1506. The light modulator 1600 shown in FIG. 16 has three light blocking portions 1606a-1606c, each of which includes a rectangular depression 1613 extending along its entire width. The sidewall reflectors 1610b-1610g are positioned on both edges of each light blocking portions 1606 and are not separated by gaps from the light blocking portions 1606. The light modulator 1600 also includes two additional sidewall reflectors 1610a and 1610h that are adjacent to the actuators 1612a and 1612b, respectively.

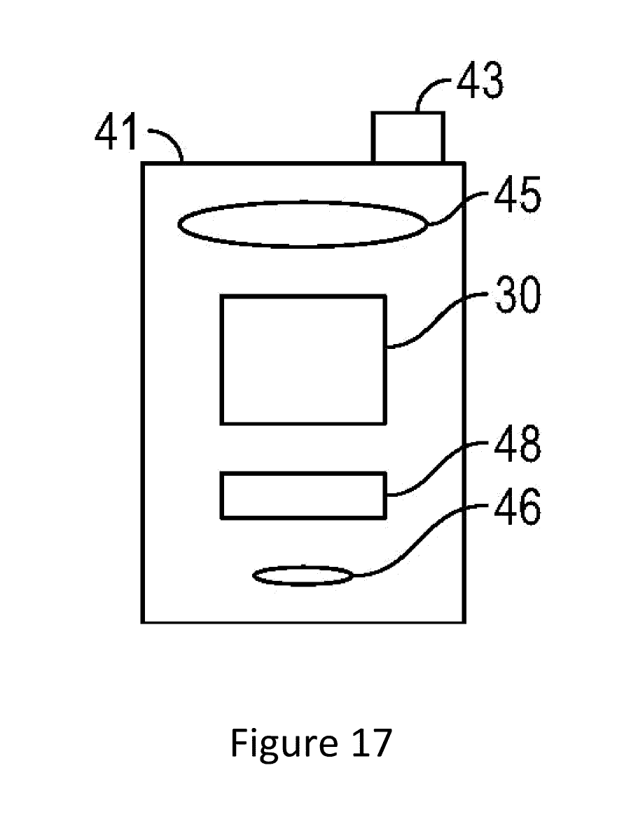

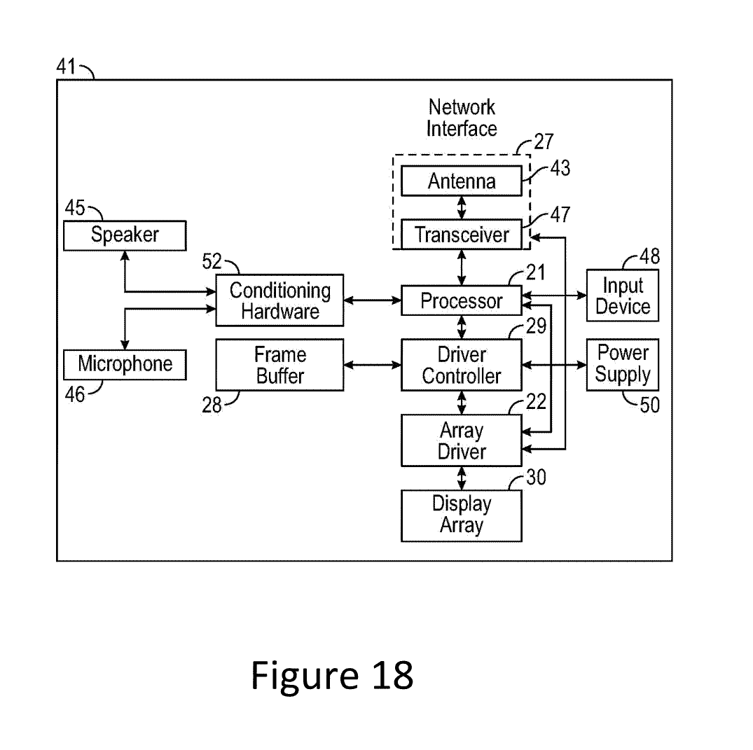

FIGS. 17 and 18 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display. The display 30 also can include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 17. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIGS. 17 and 18, can be capable of functioning as a memory device and communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of acting as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a substrate; and
a display element including:
a light blocking component suspended over the substrate, the light blocking component including:
an aperture formed through a surface of the light blocking component that is substantially parallel to the substrate, wherein the aperture has a perimeter edge, a first axis and a second axis, and wherein the first axis is longer than, and perpendicular to, the second axis; and
a first sidewall positioned within the aperture and spaced away from the perimeter edge of the aperture, extending substantially parallel to the first axis and oriented at least partially normal to the surface of the light blocking component.

2. The display apparatus of claim 1, further comprising a second sidewall positioned within the aperture substantially parallel to the first sidewall.

3. The display apparatus of claim 2, wherein the first sidewall is at least partially curved away from the second sidewall.

4. The display apparatus of claim 1, wherein the surface of the light blocking component includes a plurality of layers of material and the sidewall includes a fewer number of layers of material than the surface of the light blocking component.

5. The display apparatus of claim 1, wherein the first sidewall is spaced less than or equal to about three microns from a closest edge of the perimeter edge of the aperture.

6. The display apparatus of claim 1, further comprising a light blocking layer (LBL) disposed on the substrate including a LBL aperture defined therethrough, wherein:
the LBL aperture has a LBL perimeter edge, and
when the light blocking component is in a light blocking position with respect to light passing through the LBL aperture, the first sidewall is positioned a distance away from the LBL perimeter edge in a direction parallel to the second axis that is greater than a height of a gap between the LBL and the first sidewall.

7. The display apparatus of claim 1, wherein at least one surface of the first sidewall has a reflectance of greater than about 75%.

8. The display apparatus of claim 1, further comprising:
a display including the display element;
a processor that is capable of communicating with the display, the processor being capable of processing image data; and
a memory device that is capable of communicating with the processor.

9. The display apparatus of claim 8, further comprising:
a driver circuit capable of sending at least one signal to the display; and
a controller capable of sending at least a portion of the image data to the driver circuit.

10. The display apparatus of claim 8, further comprising:
an image source module capable of sending the image data to the processor, wherein the image source module includes at least one of a receiver, transceiver, and transmitter.

11. The display apparatus of claim 8, further comprising:
an input device capable of receiving input data and communicating the input data to the processor.

12. A method of forming a display apparatus, comprising:
providing a mold over a substrate for portions of a light blocking component;
depositing a structural material over the mold such that the deposited structural material coats the exposed surfaces of the mold;
patterning the structural material to define:
the light blocking component;
a light blocking component aperture formed through a surface of the light blocking component that is substantially parallel to the substrate, wherein the aperture has a perimeter edge, a first axis, and a second axis, and wherein the first axis is longer than, and perpendicular to, the second axis; and
a first sidewall positioned within the aperture and spaced away from the perimeter edge of the aperture, extending substantially parallel to the first axis and oriented at least partially normal to the surface of the light blocking component; and
removing the mold.

13. The method of claim 12, wherein patterning the structural material further includes patterning the structural material to define the first sidewall such that the first sidewall is spaced less than or equal to about three microns from a closest edge of the perimeter edge of the aperture.

14. The method of claim 12, wherein patterning the structural material further includes patterning the structural material to define a second sidewall positioned within the aperture substantially parallel to the first sidewall.

15. The method of claim 14, wherein patterning the structural material further includes patterning the structural material such that the first sidewall is at least partially curved away from the second sidewall.

16. The method of claim 12, further comprising:
prior to providing the mold, depositing a light blocking layer (LBL) over the substrate and patterning the LBL to define an LBL aperture having a perimeter edge;
providing the mold such that a thickness of the mold is equal to the desired height of a gap between the LBL and the light blocking component; and
patterning the LBL to define the LBL aperture such that when the light blocking component is in a light blocking position with respect to light passing through the LBL aperture, the first sidewall is positioned a distance away from the LBL perimeter edge in a direction parallel to the second axis that is greater than the height of the gap between the LBL and the first sidewall.

17. The method of claim 12, further comprising selecting the structural material to have a reflectance of greater than about 75%.

18. The method of claim 12, further comprising:
depositing additional layers of structural material; and
patterning the structural material such that the first sidewall includes a fewer number of layers of structural material than the surface of the light blocking component.

19. A display apparatus, comprising:
light blocking means suspended over a substrate and capable of moving in a plane parallel to the substrate, the light blocking means including:
a light transmitting means formed through a surface of the light blocking means that is substantially parallel to the substrate to allow light to pass through a portion of the light blocking means, wherein the light transmitting means includes a perimeter edge; and
light reflecting means positioned within the light transmitting means, spaced away from the perimeter edge and oriented at least partially normal to the surface of the light blocking means.

20. The display apparatus of claim 19, wherein the light reflecting means is spaced less than or equal to about three microns from a closest edge of the perimeter edge of the light transmitting means.
